(19) United States
(12) Patent Application Publication
(10) Pub. No.: US 2014/0310541 A1
(43) Pub. Date: Oct. 16, 2014

(54) Power Gating Shared Logic

(71) Applicant: ADVANCED MICRO DEVICES, INC., Sunnyvale, CA (US)

(72) Inventor: Steven J. Kommrusch, Fort Collins, CO (US)

(73) Assignee: Advanced Micro Devices, Inc., Sunnyvale, CA (US)

(21) Appl. No.: 13/863,238

(22) Filed: Apr. 15, 2013

(51) Int. Cl. G06F 1/32

(52) U.S. Cl. CPC G06F 1/3234
USPC 713/320; 713/300

(57) ABSTRACT

We report methods, integrated circuit devices, and fabrication processes relating to power management transitions of multiple compute units sharing a resource. One method include, in response to an indication that a first compute unit of a plurality of compute units is attempting to enter a normal power state and in response to no other compute units being in a low power state, causing a resource to enter the normal power state, wherein the plurality of compute units share the resource; and causing the first compute unit to enter the normal power state.

### BACKGROUND

1. Technical Field

Generally, the disclosed embodiments relate to integrated circuits, and, more particularly, to power management of multiple compute units sharing a common resource, such as cache memory.

2. Description of the Related Art

A computer system comprising two or more compute units (e.g., cores of a central processing unit (CPU)) can place those compute units into a lower power state when they are not needed to perform user- or system-requested operations. Placing unneeded compute units into a lower power state may reduce power consumption and heat generation by the computer system, thereby reducing operating expenses of the computer system and extending the service life of the computer system or components thereof. It is common for a computer system to contain a central power management unit (PMU) to orchestrate the low power transitions for each of the compute units within the system. Typically, the PMU can make requests directly to each compute unit to independently power down and power up.

At times, the compute units may share a resource, such as an internal cache of a multicore CPU. When a compute unit is directed to power down, one issue to be addressed is the problem of shutting down any associated shared resource that may be shared with another compute unit. Commonly, when a compute unit is directed to power down, a PMU must track the power state of the compute unit, the other compute units, and the shared resource, in order to determine whether the shared resource may be powered down. This leads to relatively large design complexity, with separate sets of logic elements managing the power states and transitions therebetween for each compute unit and the shared resource. It may also lead to inefficient management of transitions, with one or more compute units and/or the shared resource remaining in a high power state longer than is needed, thereby wasting power and generating heat; or remaining in a low power state longer than is desired, thereby delaying various operations of the computer system.

### SUMMARY OF EMBODIMENTS

The apparatuses, systems, and methods in accordance with the embodiments disclosed herein may facilitate power management of multiple compute units sharing a resource by using logic elements that power up or down a shared resource based on powering up the first compute unit to exit a low power state or powering down the last compute to enter the low power state, respectively. Mechanisms controlling and implementing such a process may be formed within a microcircuit by any means, such as by growing or deposition.

Some embodiments provide an integrated circuit device, comprising a plurality of compute units; a resource shared by the plurality of compute units; and a power management unit configured to, in response to an indication that a first compute unit of a plurality of compute units is attempting to enter a normal power state and in response to no other compute units being in a low power state, cause the resource to enter the normal power state; and cause the first compute unit to enter the normal power state.

Some embodiments provide an integrated circuit device, comprising a plurality of compute units; a resource shared by the plurality of compute units; and a power management unit configured to, in response to an indication that a first compute unit of the plurality of compute units is attempting to enter a low power state and in response to no other compute units being in the normal power state, cause the first compute unit to enter the low power state, and after the first compute unit has entered the lower power state, cause the resource to enter the low power state.

Some embodiments provide a method that includes, in response to an indication that a first compute unit of a plurality of compute units is attempting to enter a normal power state and in response to no other compute units being in a low power state, causing a resource to enter the normal power state, wherein the plurality of compute units share the resource; and causing the first compute unit to enter the normal power state.

Some embodiments provide a method that includes, in response to an indication that a first compute unit of a plurality of compute units is attempting to enter a low power state and in response to no other compute units being in the normal power state, causing the first compute unit to enter the low power state, and after the first compute unit has entered the lower power state, causing a resource to enter the low power state, wherein the plurality of compute units share the resource.

The embodiments described herein may be used in any type of integrated circuit that uses multiple compute units, a shared cache unit, and a power management unit. One example is a general purpose microprocessor.

### BRIEF DESCRIPTION OF THE FIGURES

The disclosed subject matter will hereafter be described with reference to the accompanying drawings, wherein like reference numerals denote like elements, and:

FIG. 1 is a schematic diagram of an exemplary microcircuit design in accordance with some embodiments.

FIG. 2 is a schematic diagram of a power management unit, and a CPU comprising multiple compute units and an internal cache, depicted in FIG. 1, in accordance with some embodiments.

FIG. 3 provides a representation of a processor depicted in FIG. 1, in accordance with some embodiments.

FIG. 4A provides a representation of a silicon die/chip that includes one or more circuits as shown in FIG. 3, in accordance with some embodiments.

FIG. 4B provides a representation of a silicon wafer which includes one or more dies/chips that may be produced in a fabrication facility, in accordance with some embodiments.

FIG. 5 is a flowchart of a method relating to entering a first compute unit and a shared resource into a normal power state, in accordance with some embodiments.

FIG. 6 is a flowchart of a method relating to entering a first compute unit and a shared resource into a low power state, in accordance with some embodiments.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Illustrative embodiments are described below. In the interest of clarity, not all features of an actual implementation are described in this specification. It should be appreciated that in the development of any such actual embodiment, numerous implementation-specific decisions should be made, which may vary from one implementation to another. Moreover, it should be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

Embodiments provide for facilitating power management of multiple compute units (e.g., cores) sharing a resource. Because prior management of power transitions involving a compute unit and a resource shared by it typically requires either waiting for all the compute units, or full and separate power management logic for each compute unit and resource, various embodiments of facilitated power management allow a reduced set of logic elements to manage power transitions of the shared resource as part of the process of manage power transitions of the compute units. Thereby, power state transitions may be performed with relatively low design complexity, relatively high speed, and minimal noise.

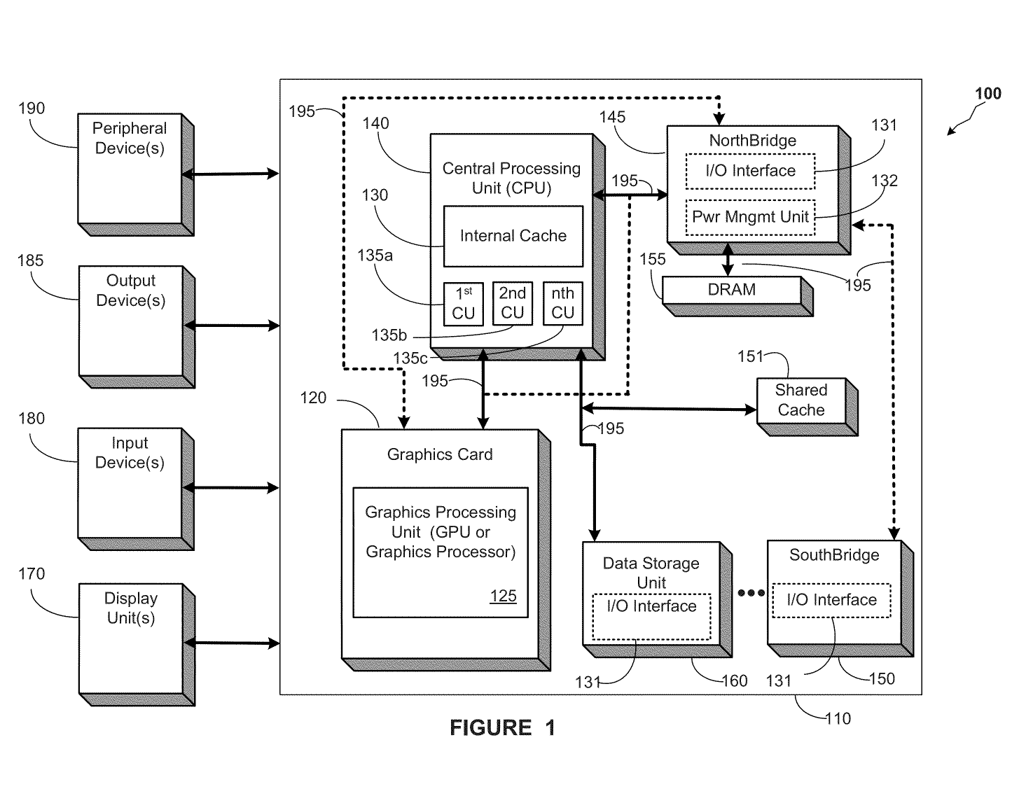

Turning now to FIG. 1, a block diagram representation of a computer system 100 comprising a processor 110, in accordance with some embodiments, is illustrated. Modern computer systems may exist in a variety of forms, such as telephones, tablet computers, desktop computers, laptop computers, servers, smart televisions, or other consumer electronic devices. The processor unit 110 may comprise one or more central processing units (CPUs) 140, each of which may comprise various compute units (CUs) 135, e.g. first CU 135a, second CU 135b, through N^{th} CU 135c). Each of the CPUs 140 may also comprise an internal cache 130 that provides a shared resource (in this case, cache memory) for the CUs 135. The processor unit 110 may also comprise a shared cache 151 of memory resources shared among the various CPUs 140, compute units 135 of one or more CPUs 140, and/or graphics processing units (GPUs) 125 of a graphics card 120.

The computer system 100 may also comprise a northbridge 145. Among its various components, the northbridge 145 may comprise a power management unit (PMU) 132 that may regulate the amount of power consumed by the compute units 135, internal cache 130, CPUs 140, GPUs 125, and/or the SCU 152. Particularly, in response to changes in demand for the compute units 135, CPUs 140, and/or GPUs 125, the PMU 132 may request each of the plurality of compute units 135, internal cache 130, CPUs 140, shared cache 151, and/or GPUs 125 to enter a low power state, exit the low power state, enter a normal power state, or exit the normal power state.

The computer system 100 may also comprise a DRAM 155. The DRAM 155 may be configured to store one or more states of one or more components of the computer system 100. Particularly, the DRAM 155 may be configured to store one or more states of the compute units 135, the internal cache 130, the shared cache 151, one or more CPUs 140, and/or one or more GPUs 125.

The computer system 100 may as a routine matter comprise other known units and/or components, e.g., one or more I/O interfaces 131, a southbridge 150, a data storage unit 160, display unit(s) 170, input device(s) 180, output device(s) 185, and/or peripheral devices 190, among others.

The computer system 100 may also comprise one or more data channels 195 for communication between one or more of the components described above.

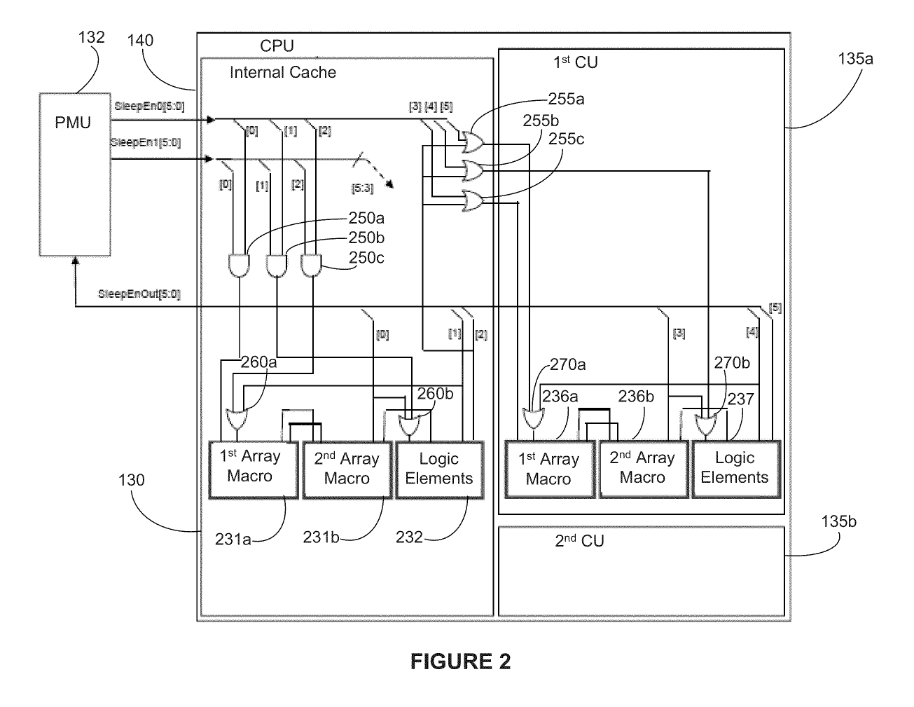

FIG. 2 shows in more detail components of the internal cache 130 and the first CU 135a in accordance with some embodiments. In some embodiments, the internal cache 130 comprises a plurality of array macros, e.g., first array macro 231a, second array macro 231b, etc. The internal cache 130 may also comprise logic elements 232. Similarly, in some embodiments, the first CU 135a comprises a plurality of array macros, e.g., first array macro 236a, second array macro 236b, etc. The first CU 135a may also comprise logic elements 237. The second CU 135b may have the same components as the first CU 135a, and for that reason will not be discussed in detail for the sake of convenience.

FIG. 2 also shows a PMU 132 configured to request each of the compute units 135a and 135b and internal cache 130 to enter a low power state, exit the low power state, enter a normal power state, or exit the normal power state. Herein, a low power state may be referred to as “sleep.” These requests may be relayed by SleepEn0[5:0] to the first compute unit 135a via OR gates 255a, 255b, and 255c, and the internal cache 130 via AND gates 250a, 250b, and 250c. These requests may be relayed by SleepEn1[5:0] to the second compute unit 135b, and to the internal cache 130 via AND gates 250a, 250b, and 250c. Each of the first compute unit 135a, the second compute unit 135b, and/or the internal cache 130 may also provide SleepEnOut[5:0]. In some embodiments, each unit 130, 135a, and 135b may generate a local SleepEnOut, which may be routed in daisy chain fashion to the next unit as the following unit's SleepEn. The last unit in the chain may generate SleepEnOut to the PMU 132. SleepEnOut may be usable by the PMU 132 to time subsequent sleep state transitions. As shown in FIG. 2, SleepEnOut allows a desired power setting to be applied to a given unit before the next unit begins powering up.

In some embodiments, such as that shown in FIG. 2, the depicted components may function such that when only one compute unit (e.g., first CU 135a) is active, the enables for that compute unit control the shared resource (e.g., internal cache 130), as well as the compute unit. As depicted, bits [2:0] of SleepEn0 sequence the internal cache 130 first and bits [5:3] sequence the first CU 135a, which can only get power when the internal cache 130 has power. This may be effected by the most significant bit of the final power block in the internal cache 130 being used to keep the first compute unit 135a in sleep until the internal cache 130 is no longer in sleep.

Table 1 shows the results of one-bit steps through the sequence SleepEn0[5:0] for powering up (exiting sleep, entering a normal power state) for first CU 135a. It is assumed that SleepEn1[5:0] is high (i.e., the second CU 135b is in sleep and will remain in sleep), and only SleepEn0[5:0] is changing.

TABLE 1
SleepEn0[5:0] setting

| Start | End | Description |
|---|---|---|
| 111111 | 111110 | Array macros 231a, 231b in the internal cache 130 |
| | | get high resistance connection to power. Arrays |
| | | power up combinatorially in series. |
| 111110 | 111100 | Logic element 232 in the internal cache 130 gets |
| | | high resistance connection to power. |
| 111100 | 111000 | The lowest resistance connection to power for the |
| | | internal cache 130 propagates through array macros |
| | | 231a, 231b and then propagates to the logic |
| | | elements 232. |
| 111000 | 110000 | Array macros 236a, 236b in first CU 135a get high |
| | | resistance connection to power. |
| 110000 | 100000 | Logic element 237 in first CU 125a gets high |
| | | resistance connection to power. |
| 100000 | 000000 | The lowest resistance connection to power for the |
| | | first CU 135a propagates through array macros 236a, |
| | | 236b and then propagates to the logic elements 237. |

Although Table 1 is broken out into one-bit steps through the sequence, depending on capacitances involved in the various components and/or propagation delays, PMU 132 could have gone from SleepEn0[5:0]=111111 to SleepEn0[5:0]=000000 in one step, yet the power up sequence would still follow the description order in the table. This results from the SleepEnOut signal being an input to OR gates 255a, 255b, and 255c along with the direct SleepEn0 control from PMU 132. This sequence allows a relatively gentle power up, with minimal noise.

In the case where the second CU 135b already has power, i.e., SleepEn1[5:0]=000000, the internal cache 130 would already have power when stepping through powering up of first CU 135a. (The outputs of AND gates 250a, 250b, and 250c would be and remain 0, indicative of a normal power state to the components 231a, 231b, and 232 of internal cache 130). Then only the transition power up steps from SleepEn0[5:0]=111000 to SleepEn0[5:0]=000000 would change the power state of any component, viz., first CU 135a. The PMU 132 would not need to be aware of the internal cache 130. The PMU 132 can simply sequence the SleepEn signals per compute unit 135a, 135b, and the depicted logic handles the power sharing between the compute units 135a, 135b and the internal cache 130.

In the case of powering off a core, consider the case where only first CU 135a still has power (i.e., SleepEn0[5:0]=000000, and for second CU 135b, SleepEn1[5:0]=111111) and PMU 132 changes SleepEn0 to 111111 in one step. High resistance power connections, e.g. parallel wide PFET transistors having an effective resistance of about 0.1 ohms, to the first CU 135a and internal cache 130 macros (231a, 231b, 236a, and 236b) and logic elements (232, 237) will have sleep set at about the same time, given that the least significant bit sleep enables pass through OR gates 255c, 260a directly to their macros. In parallel, low resistance connections, e.g., parallel wide PFET transistors having an effective resistance of about 1 milliohm, will propagate through the design. The propagation for enabling sleep is thus parallelized between the first CU 135a and the internal cache 130. As shown, the array macros 231a, 231b in the internal cache 130 would have their low resistance connection removed, followed by removal of the low resistance connection to the logic elements 232. In parallel the first CU 135a would have the low resistance connection removed from the array macros 236a, 236b first, and second from the logic elements 237. This sequence allows a relatively gentle power off, with minimal noise.

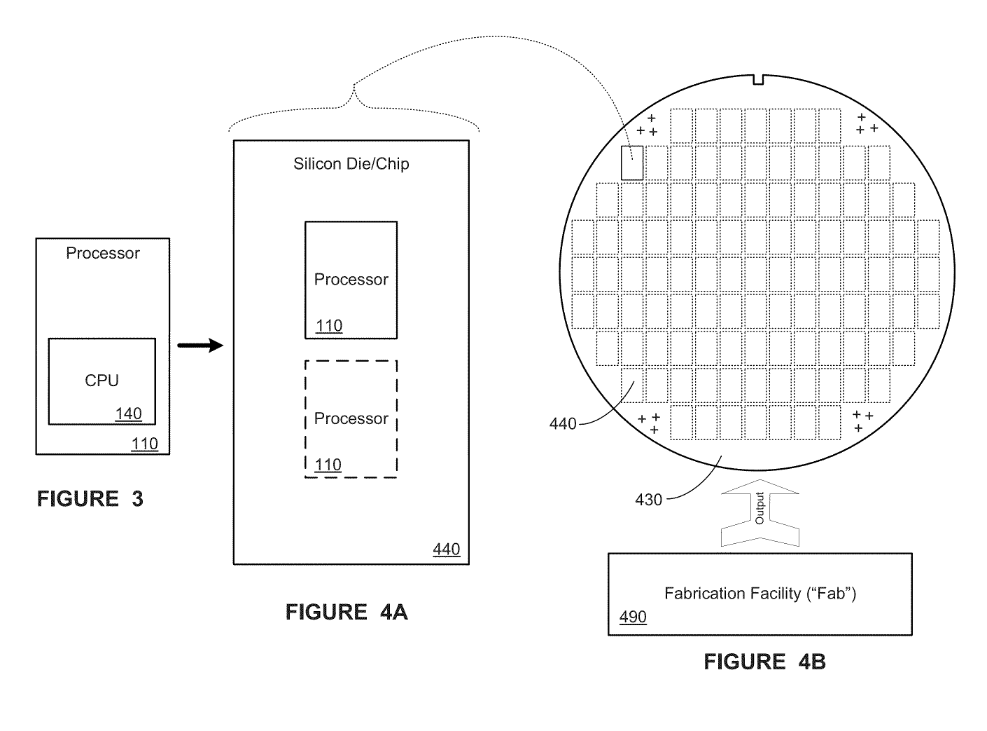

Turning now to FIG. 3 and FIG. 4A, in some embodiments, the processor unit 110 comprising a CPU 140 may reside on a silicon die/chip 440. The silicon die/chip 440 may be housed on a motherboard or other structure of the computer system 100. In some embodiments, there may be more than one processor unit 110 on each silicon die/chip 440. Some embodiments of the processor unit 110 may be used in a wide variety of electronic devices.

Turning now to FIG. 4B, in accordance with some embodiments, and as described above, the processor unit 110 may be included on the silicon chip/die 440. The silicon chip/die 440 may contain one or more different configurations of the processor unit 110. The silicon chip/die 440 may be produced on a silicon wafer 430 in a fabrication facility (or “fab”) 490. That is, the silicon wafer 430 and the silicon die/chip 340 may be referred to as the output, or product of, the fab 490. The silicon chip/die 440 may be used in electronic devices.

The circuits described herein may be formed on a semiconductor material by any known means in the art. Forming can be done, for example, by growing or deposition, or by any other means known in the art. Different kinds of hardware descriptive languages (HDL) may be used in the process of designing and manufacturing the microcircuit devices. Examples include VHDL and Verilog/Verilog-XL. In some embodiments, the HDL code (e.g., register transfer level (RTL) code/data) may be used to generate GDS data, GDSII data and the like. GDSII data, for example, is a descriptive file format and may be used in some embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, compact discs, DVDs, solid state storage and the like) and, in some embodiments, may be used to configure a manufacturing facility (e.g., through the use of mask works) to create devices capable of embodying various aspects of some embodiments. As understood by one or ordinary skill in the art, this data may be programmed into a computer, processor, or controller, which may then control, in whole or part, the operation of a semiconductor manufacturing facility (or fab) to create semiconductor products and devices. In other words, some embodiments relate to a non-transitory computer-readable medium storing instructions executable by at least one processor to fabricate an integrated circuit. These tools may be used to construct the embodiments described herein.

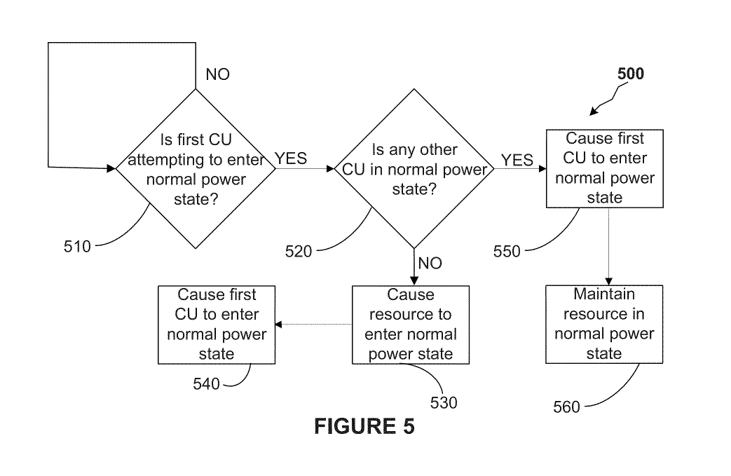

FIG. 5 presents a flowchart depicting a method 500 according to some embodiments. In some embodiments, the PMU 132 performs the method 500. As illustrated in FIG. 5, the PMU 132 determining (at 510) (e.g., by receiving an indication) that a first compute unit of a plurality of compute units is attempting to enter a normal power state. When the PMU 132 determines (at 520) that no other compute unit of the plurality is in a normal power state (i.e., all the compute units are in a low power state, and a resource shared by the plurality of compute units is not in use and presumably also in the low power state to save power), the PMU 132 causes (at 530) the shared resource (e.g., an internal cache) to enter the normal power state and causes (at 540) the first compute unit to enter the normal power state.

In some embodiments, the PMU 132 causes (at 530) the shared resource to enter the normal power state by causing a first resistance to connect at least one array macro of the resource to a power supply, the first resistance to connect at least one logic element of the resource to the power supply, a second resistance to connect the at least one array macro of the resource to the power supply, and the second resistance to connect the at least one logic element of the resource to the power supply, wherein the first resistance is higher than the second resistance.

In some embodiments, the PMU 132 causes (at 540) the first compute unit to enter the normal power state by causing a first resistance to connect at least one array macro of the first compute unit to a power supply, the first resistance to connect at least one logic element of the first compute unit to the power supply, a second resistance to connect the at least one array macro of the first compute unit to the power supply, and the second resistance to connect the at least one logic element of the first compute unit to the power supply, wherein the first resistance is higher than the second resistance.

When the PMU 132 determines (at 520) that at least one other compute unit of the plurality is in the normal power state (i.e., the shared resource is presumably also in the normal power state, given that at least one other compute unit of the plurality is in a normal power state and presumably requiring the shared resource), the PMU 132 causes (at 550) the first compute unit to enter the normal power state and causes (at 560) the shared resource (e.g., the internal cache) to be maintained in the normal power state.

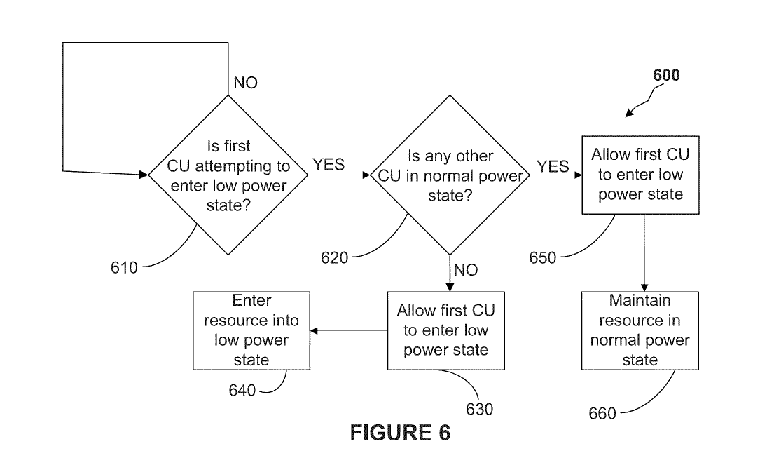

FIG. 6 presents a flowchart depicting a method 600 according to some embodiments. In some embodiments, the PMU 132 performs the method 600. As illustrated in FIG. 6, the PMU 132 may determine (at 610) (e.g., by receiving an indication) that a first compute unit of a plurality of compute units is attempting to enter a low power state. When the PMU 132 determines (at 620) that no other compute unit of the plurality is in a normal power state (i.e., the first compute unit is the only compute unit in the normal power state and requiring a shared resource to also be in a normal power state), the PMU 132 causes (at 630) first compute unit to enter the low power state and causes (at 640) the shared resource to enter the low power state.

In some embodiments, the PMU 132 causes (at 630) the first compute unit to enter the low power state by substantially simultaneously causing a first resistance connecting the first compute unit to a power supply to be disconnected and causing a second resistance connecting the first compute unit to the power supply to be disconnected.

In some embodiments, the PMU 132 causes (at 640) the resource to enter the low power state by substantially simultaneously causing a first resistance connecting the resource to a power supply to be disconnected and causing a second resistance connecting the resource to the power supply to be disconnected. In some embodiments, the PMU 132 may cause both the resource and the compute unit to be substantially simultaneously disconnected from the power supplies.

When the PMU 132 determines (at 620) that at least one other compute unit of the plurality is in the normal power state (i.e., the shared resource is presumably also in the normal power state, given that at least one other compute unit of the plurality is in a normal power state and presumably requiring the shared resource), the PMU 132 causes (at 650) the first compute unit to enter the low power state and causes (at 660) the shared resource (e.g., the internal cache) to be maintained in the normal power state.

The methods illustrated in FIGS. 5-6 may be governed by instructions that are stored in a non-transitory computer readable storage medium and that are executed by at least one processor of the computer system 100. Each of the operations shown in FIGS. 5-6 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Embodiments of processor systems that can allocate a store queue entries to store instructions for the PMU, cache control processes, and other control processes described herein (such as the processor system 100) may be fabricated in semiconductor fabrication facilities according to various processor designs. In one embodiment, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

Furthermore, the methods disclosed herein may be governed by instructions that are stored in a non-transitory computer readable storage medium and that are executed by at least one processor of a computer system. Each of the operations of the methods may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed:

1. A method, comprising:
in response to an indication that a first compute unit of a plurality of compute units is attempting to enter a normal power state and in response to no other compute units being in a low power state,
causing a resource to enter the normal power state, wherein the plurality of compute units share the resource; and
causing the first compute unit to enter the normal power state.

2. The method of claim 1, wherein causing the resource to enter the normal power state comprises:
causing a first resistance to connect the resource to a power supply; and
causing a second resistance to connect the resource to the power supply, wherein the first resistance is higher than the second resistance.

3. The method of claim 2,
wherein causing the first resistance to connect the resource to the power supply comprises:
causing the first resistance to connect at least one array macro of the resource to the power supply; and
causing the first resistance to connect at least one logic element of the resource to the power supply; and
wherein causing the second resistance to connect the resource to the power supply comprises:
causing the second resistance to connect the at least one array macro of the resource to the power supply; and
causing the second resistance to connect the at least one logic element of the resource to the power supply.

4. The method of claim 1, wherein causing the first compute unit to enter the normal power state comprises:
causing a first resistance to connect the first compute unit to a power supply; and
causing a second resistance to connect the first compute unit to the power supply, wherein the first resistance is higher than the second resistance.

5. The method of claim 4,
wherein causing the first resistance to connect the first compute unit to the power supply comprises:
causing the first resistance to connect at least one array macro of the first compute unit to the power supply; and
causing the first resistance to connect at least one logic element of the first compute unit to the power supply; and
wherein causing the second resistance to connect the first compute unit to the power supply comprises:
causing the second resistance to connect the at least one array macro of the first compute unit to the power supply; and
causing the second resistance to connect the at least one logic element of the first compute unit to the power supply.

6. The method of claim 1, wherein when at least one other compute unit is in the normal power state, the method further comprises causing the first compute unit to enter the normal power state and causing the resource to be maintained in the normal power state.

7. A method, comprising:
in response to an indication that a first compute unit of a plurality of compute units is attempting to enter a low power state and in response to no other compute units being in the normal power state:
causing the first compute unit to enter the low power state, and
after the first compute unit has entered the lower power state, causing a resource to enter the low power state, wherein the plurality of compute units share the resource.

8. The method of claim 7, wherein when at least one other compute unit is in the normal power state, the method further comprises:
causing the first compute unit to enter the low power state; and
causing the resource to be maintained in the normal power state.

9. The method of claim 7, wherein causing the resource to enter the low power state comprises substantially simultaneously causing a first resistance connecting the resource to a power supply to be disconnected and causing a second resistance connecting the resource to the power supply to be disconnected, wherein the first resistance is higher than the second resistance.

10. The method of claim 7, wherein causing the first compute unit to enter the low power state comprises substantially simultaneously causing a first resistance connecting the first compute unit to a power supply to be disconnected and causing a second resistance connecting the resource to the power supply to be disconnected, wherein the first resistance is higher than the second resistance.

11. An integrated circuit device, comprising:
a plurality of compute units;
a resource shared by the plurality of compute units; and
a power management unit configured to, in response to an indication that a first compute unit of a plurality of compute units is attempting to enter a normal power state and in response to no other compute units being in a low power state, cause the resource to enter the normal power state; and cause the first compute unit to enter the normal power state.

12. The integrated circuit device of claim 11, wherein the power management unit is configured to cause the resource to enter the normal power state by causing a first resistance to connect the resource to a power supply; and causing a second resistance to connect the resource to the power supply, wherein the first resistance is higher than the second resistance.

13. The integrated circuit device of claim 12, wherein the power management unit is configured to:
cause the first resistance to connect the resource to the power supply by causing the first resistance to connect at least one array macro of the resource to the power supply; and causing the first resistance to connect at least one logic element of the resource to the power supply; and
cause the second resistance to connect the resource to the power supply by causing the second resistance to connect the at least one array macro of the resource to the power supply; and
causing the second resistance to connect the at least one logic element of the resource to the power supply.

14. The integrated circuit device of claim 11, wherein the power management unit is configured to cause the first compute unit to enter the normal power state by causing a first resistance to connect the first compute unit to a power supply; and causing a second resistance to connect the first compute unit to the power supply, wherein the first resistance is higher than the second resistance.

15. The integrated circuit device of claim 14, wherein the power management unit is configured to:
cause the first resistance to connect the first compute unit to the power supply by causing the first resistance to connect at least one array macro of the first compute unit to the power supply; and causing the first resistance to connect at least one logic element of the first compute unit to the power supply; and
cause the second resistance to connect the first compute unit to the power supply by causing the second resistance to connect the at least one array macro of the first compute unit to the power supply; and causing the second resistance to connect the at least one logic element of the first compute unit to the power supply.

16. The integrated circuit device of claim 11, wherein the power management unit is further configured to, when at least one other compute unit is in the normal power state, cause the first compute unit to enter the normal power state and causing the resource to be maintained in the normal power state.

17. An integrated circuit device, comprising:
a plurality of compute units;
a resource shared by the plurality of compute units; and
a power management unit configured to, in response to an indication that a first compute unit of the plurality of compute units is attempting to enter a low power state and in response to no other compute units being in the normal power state, cause the first compute unit to enter the low power state, and after the first compute unit has entered the lower power state, cause the resource to enter the low power state.

18. The integrated circuit of claim 17, wherein the power management unit is further configured to, when at least one other compute unit is in the normal power state, cause the first compute unit to enter the low power state; and cause the resource to be maintained in the normal power state.

19. The integrated circuit of claim 17, wherein the power management unit is configured to cause the resource to enter the low power state by substantially simultaneously causing a first resistance connecting the resource to a power supply to be disconnected and causing a second resistance connecting the resource to the power supply to be disconnected, wherein the first resistance is higher than the second resistance.

20. The integrated circuit of claim 17, wherein the power management unit is configured to cause the first compute unit to enter the low power state by substantially simultaneously causing a first resistance connecting the first compute unit to a power supply to be disconnected and causing a second resistance connecting the resource to the power supply to be disconnected, wherein the first resistance is higher than the second resistance.
